(19) United States
(12) Patent Application Publication
(10) Pub. No.: US 2008/0270524 A1
(43) Pub. Date: Oct. 30, 2008

(54) DISTRIBUTING FILES OVER A COMPUTER NETWORK

(76) Inventors: Nikhil Gupta, Cedar Park, TX (US); Lawrence H. Maddox, Austin, TX (US); Liliana Orozco, Del Valle, TX (US); Brian George Vaseberg, Austin, TX (US)

Correspondence Address: IBM CORP (YA);C/O YEE & ASSOCIATES PC, P.O. BOX 802333, DALLAS, TX, 75380, US

(21) Appl. No.: 11/742,188

(22) Filed: Apr. 30, 2007

(51) Int. Cl. G06F 15/16

(52) U.S. Cl. 709/203

(57) ABSTRACT

A computer implemented method, apparatus, and computer program product for distributing files. A configurable threshold is set. A notification of a file to upload is received. An entry for the file is created in a database. A determination as to whether the size of the file is less than the configurable threshold is made. Responsive to a determination that the size of the file is greater than or equal to the configurable threshold, the file is copied to a plurality of servers, and the entry in the database is updated by adding the locations of the plurality of servers. Responsive to a determination that the file is less than the configurable threshold, the file is stored in a storage, and the entry in the database is updated with the location of the file.

### BACKGROUND OF THE INVENTION

1. Field of the Invention

The present invention relates generally to data processing systems and in particular to file distribution systems. Still more particularly, the present invention relates to a computer implemented method, apparatus, and computer program code for distributing files in a computer network.

2. Description of the Related Art

Dynamic content delivery is a service which uses a specially designed computer system for efficiently distributing large files to multiple clients. In a dynamic content delivery system, a file is published by uploading it to a depot server. The file is then copied across the network to other depot servers. When a client requests a file download, a download plan is created and sent to the client.

The download plan typically contains a client specific authorization to download the file using the dynamic content delivery system and the detailed plan for downloading the file. The detailed plan contains one or more locations, such as depot servers, where the file is available for download. The detailed plan also specifies various aspects of the download process, including the maximum download speed for each source, the number of simultaneous connections to open at a time, and the minimum and maximum segment size.

The client uses the download plan to open connections to multiple depot servers and simultaneously retrieve different segments of the file from different depot servers. The dynamic content delivery system is designed for efficiently distributing large files. However, a small file, which has a size less than a configurable threshold file size, may not be handled very efficiently in the dynamic content delivery system. For example, resources may be needlessly expended replicating a small file to multiple depot servers, even though the file does not need to be downloaded in segments because the file is smaller than a typical segment of a large file.

### SUMMARY OF THE INVENTION

The illustrative embodiments described herein provide a computer implemented method, apparatus, and computer program product for distributing files. A configurable threshold is set. A notification of a file to upload is received. An entry for the file is created in a database. A determination as to whether the size of the file is less than the configurable threshold is made. Responsive to a determination that the size of the file is greater than or equal to the configurable threshold, the file is copied to a plurality of servers, and the entry in the database is updated by adding the locations of the plurality of servers. Responsive to a determination that the file is less than the configurable threshold, the file is stored in a storage accessible by a central storage manager, and the entry in the database is updated with the location of the file.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 is a block diagram of a data processing system in which illustrative embodiments may be implemented;

FIG. 3 is a block diagram of a computer system designed for dynamic content delivery in accordance with an illustrative embodiment;

FIG. 4 is a flowchart of a process for processing a file upload in a dynamic content delivery system in accordance with an illustrative embodiment; and

FIG. 5 is a flowchart of a process for processing a file download request in a dynamic content delivery system in accordance with an illustrative embodiment.

### DETAILED DESCRIPTION OF THE PREFERRED EMBODIMENT

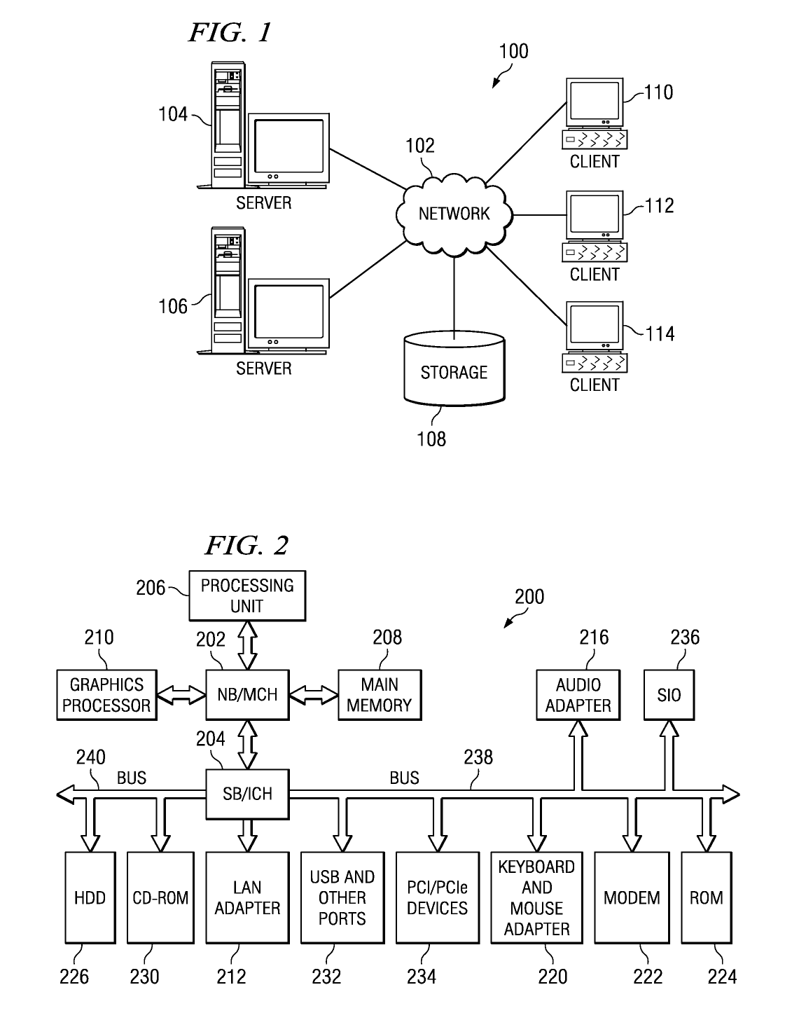

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

Servers 104 and 106 may be depot servers, each containing multiple copies of large files. Clients 110, 112, and 114 may be clients who request to download a file from the depot servers. Segments of the large file may be downloaded from both servers 104 and 106 simultaneously.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Dynamic content delivery is a service which uses a specially designed computer system for efficiently distributing large files to multiple clients. For example, a movie studio may use dynamic content distribution to deliver a movie that is several gigabytes in size to various clients, including movie theaters, movie rental stores, movie retailers, and consumers. Dynamic content delivery is designed to allow multiple clients to efficiently download the same large file.

Current dynamic content delivery systems are designed for efficiently distributing large files, such as several gigabytes or more in size. However, the illustrative embodiments recognize that the dynamic content delivery system is not very efficient when distributing files smaller than a configurable threshold, such as files ten thousand bytes in size or smaller. For example, when a file smaller than the configurable threshold is uploaded, resources are needlessly expended replicating the small file to multiple depot servers, even though the file may be smaller than one segment of a typical large file. Similarly, when the file is downloaded in a dynamic content delivery system, multiple connections are created to simultaneously download very small segments of the small file.

In many cases the time to setup the multiple connections may be longer than the time used to download the entire file. This is an example of a situation in which current content delivery systems are inefficient. Therefore, the illustrative embodiments recognize the need to be able to efficiently handle files smaller than a configurable threshold in a dynamic content delivery system designed for distributing large files.

The illustrative embodiments described herein provide a computer implemented method, apparatus, and computer program product for distributing files. A configurable threshold is set. A notification of a file to upload is received. An entry for the file is created in a database. A determination as to whether the size of the file is less than the configurable threshold is made. Responsive to a determination that the size of the file is greater than or equal to the configurable threshold, the file is copied to a plurality of servers, and the entry in the database is updated by adding the locations of the plurality of servers. Responsive to a determination that the file is less than the configurable threshold, the file is stored in a storage accessible by a central storage manager, and the entry in the database is updated with the location of the file.

When a request to download a file is received from a client, a lookup is performed to find the entry for the file in the database. A determination is made whether the size of the file is less than the configurable threshold. Responsive to a determination that the size of the file is greater than or equal to the configurable threshold, a download plan is created to use simultaneous downloads of segments of the file from the plurality of servers. Responsive to a determination that the file is less than the configurable threshold, a download plan is created and the file is copied from the storage for small files to the download plan. The download plan is sent to the client.

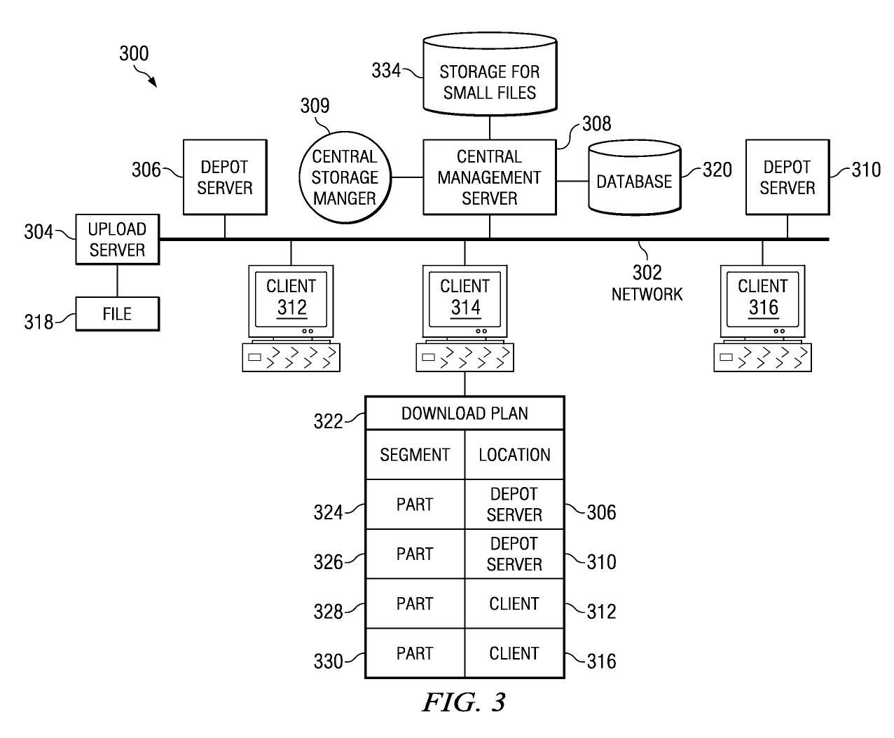

FIG. 3 is a block diagram of a computer system designed for dynamic content delivery in accordance with an illustrative embodiment. In block diagram of a computer system 300, all the clients and servers communicate with each other over network 302, which may, for example, be the Internet. Upload server 304, depot server 306, central management server 308, and depot 310 are servers, such as servers 104 and 106 in FIG. 1. Clients 312, 314, and 316 are clients such as clients 110, 112, and 114 in FIG. 1. The dynamic content delivery system may use software such as Tivoli® Provisioning Manager for Dynamic Content Delivery from International Business Machines Corporation.

Central storage manager 309 is a software process running on central management server 308. When a file is uploaded, central storage manager 309 is notified, and central storage manager 309 then copies the uploaded file to depot servers. When a client sends a request to download a file, central storage manager 309 creates a download plan for the client.

In a dynamic content delivery system, a file, such as file 318, is published by using upload server 304 to notify central storage manager 309 that a new file is ready to be uploaded. Central storage manager 309 makes an entry for file 318 in database 320. Database 320 is an information repository containing information about each uploaded file, such as when the file was uploaded, the size of the file, which depot servers host copies of the file, and how many segments the file contains. Database 320 is typically located in a server, such as server 104 in FIG. 1. Database 320 may be located in central management server 308, as shown in FIG. 3, or database 320 may be located on a remote server, such as depot server 310.

Once an entry for file 318 has been created in database 320, central storage manager 309 copies file 318 to other depot servers connected to the network, such as, for example, depot server 310. Central storage manager 309 308 updates the entry for file 318 in database 320 by adding the location of each server where a copy of the uploaded file may be found.

When a client, such as client 314, sends a request to central storage manager 309 asking to download a file, central storage manager 309 creates download plan 322 and sends download plan 322 to client 314. Download plan 322 contains information on the most efficient way to download the file requested by the client, taking into account the load on each depot server and the proximity of each depot server to the requesting client. If peer-to-peer downloading is enabled, central storage manager 309 may also include other clients, such as clients 312 and 314, which have previously downloaded file 318.

For example, assume central storage manager 309 determines that file 318 has four segments, parts 324, 326, 328, and 330. In this example, download plan 322 may specify that client 314 download part 324 from depot server 306, part 326 from depot server 310, part 328 from client 312, and part 330 from client 316. Client 314 uses download plan 322 to open connections to two depot servers and two clients in order to simultaneously retrieve four different segments of the file. Client 314 thus downloads file 318 relatively quickly compared to downloading file 318 from one depot server because of the simultaneously retrievals.

In order to more efficiently handle the distribution of files smaller than a configurable threshold, the dynamic content delivery system may be modified by adding storage for small files 334 to the dynamic content delivery system. Storage for small files 334 is a server, such as server 104 in FIG. 1. When a small file, smaller in size than a configurable threshold, is uploaded, the small file, such as file 318, may be stored in storage for small files 334. Alternately, if storage for small files 334 is not optionally added to the dynamic content delivery system, the small file may be stored in database 320.

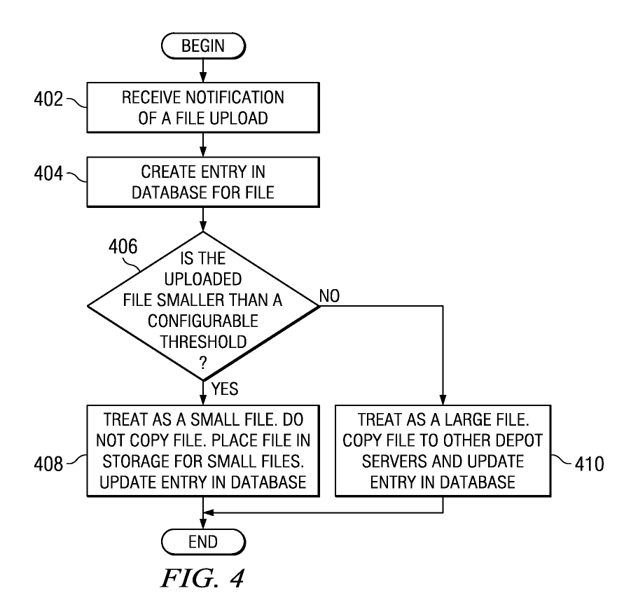

FIG. 4 is a flowchart of a process for processing a file upload in a dynamic content delivery system in accordance with an illustrative embodiment. The process in FIG. 4 may be executed by a software process, such as, central storage manager 309 in FIG. 3. In the dynamic content delivery system, a file, such as file 318 in FIG. 3, is published by using upload server 304 to upload file 318 to a depot server, such as depot server 306. Upload server 304 also notifies central storage manager 309 that a new file has been uploaded.

The process begins when a notification is received indicating a file has been uploaded to a depot server (step 402). The process creates an entry for the file in database 320 (step 404). The process determines whether the uploaded file is smaller than a configurable threshold (step 406). Based on the average size of the large files distributed in a particular dynamic content delivery system, a system administrator or other user may set an appropriate value for the configurable threshold. Files with a size less than the configurable threshold are considered “small”, while files with a size greater than or equal to the configurable threshold are considered “large”.

For example, a system administrator may specify that a configuration threshold is ten kilobytes, so that all files smaller than ten kilobytes are treated as “small” and all files larger than ten kilobytes are treated as “large”. The system administrator may use a variety of criteria to determine the value of the configurable threshold. For example, the system administrator may take into account criteria such as the time needed to set up each download connection, the average time needed to download a file segment, and the average size of a file segment.

If the answer in step 406 is “yes” and the uploaded file is smaller than the configurable threshold, then the file is treated as a small file; the file is stored in a storage for small files, and the database entry is updated with the location of the file (step 408), and the process ends. The storage for small files may be a server, such as storage for small files 334 in FIG. 3. Alternately, the storage for small files may be database 320 in FIG. 3.

Database 320 is an information repository containing information about each uploaded file, such as when the file was uploaded, the size of the file, and the set of locations where the file is stored. If the file is smaller than the configurable threshold, the set of locations stored in the database is a single server, such as storage for small file 334, or database 320. If the file is not smaller than the configurable threshold, then the set of locations stored in the database is the servers, such as depot servers 306 and 310, where copies of the file are stored. In step 406, the process updates the entry for the file in database 320 to indicate the uploaded file is smaller than the configurable threshold and so should not be copied to other depot servers.

If the answer in step 406 is “no” and the uploaded file is determined to be the same size or larger than the configurable threshold, then the file is treated as a large file in the dynamic content delivery system (step 410) and the process ends. For example, in step 410, the process may copy the uploaded file to other depot servers.

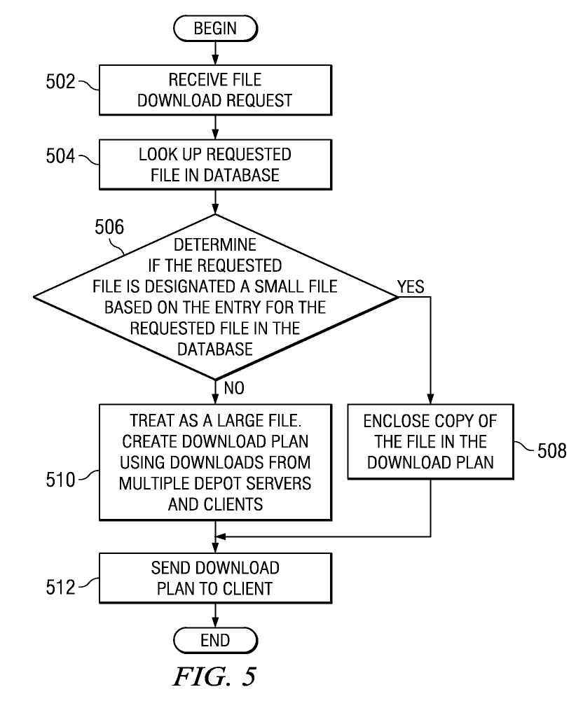

FIG. 5 is a flowchart of a process for processing a file download request in a dynamic content delivery system, in accordance with an illustrative embodiment. The process in FIG. 5 is executed by software on a computer or server, such as, central storage manager 309 in FIG. 3.

The process begins when software on a server, such as central storage manager 309, receives a file download request from a client, such as client 312 in FIG. 3 (step 502). The process looks up the file in database 320 (step 504). The process determines if the requested file is designated as a “small” file by checking the entry for the requested file in the database (step 506). If the answer in step 506 is “yes” and the file is considered “small” for the dynamic content delivery system because the file is smaller than the configurable threshold, then the file is copied and enclosed in the download plan (step 508). The file is copied from a server, such as storage for small files 334, or database 320.

If the answer in step 506 is “no” and the file is not considered “small” for the dynamic content delivery system, then a download plan is created to download the file using simultaneous connections to multiple depot servers and clients (step 510). As previously mentioned, the download plan is created taking into account different factors, such as the number of file segments, the number of depot servers hosting the file, and the number of client peers hosting the file. Once the download plan is created, the download plan is sent to the client (step 512) and the process ends.

Thus, the illustrative embodiments described herein provide a computer implemented method, apparatus, and computer program product for distributing files. A configurable threshold is set. A notification of a file to upload is received. An entry for the file is created in a database. A determination as to whether the size of the file is less than the configurable threshold is made. Responsive to a determination that the size of the file is greater than or equal to the configurable threshold, the file is copied to a plurality of servers, and the entry in the database is updated by adding the locations of the plurality of servers. Responsive to a determination that the file is less than the configurable threshold, the file is stored in a storage accessible by a central storage manager, and the entry in the database is updated with the location of the file.

When a request to download a file is received from a client, a lookup is performed to find the entry for the file in the database. A determination is made whether the size of the file is less than the configurable threshold. Responsive to a determination that the size of the file is greater than or equal to the configurable threshold, a download plan is created to use simultaneous downloads of segments of the file from the plurality of servers. Responsive to a determination that the file is less than the configurable threshold, a download plan is created and the file is copied from the storage for small files to the download plan. The download plan is sent to the client.

One advantage of using different embodiments, is that the resources required to replicate the small file to multiple depot servers are no longer used. Therefore, the resources required to create a multi-segment download plan for a small file are no longer used. Also, simultaneous connections to multiple depot servers and peers do not need to be opened and closed. The small file does not to be re-assembled from even smaller segments. In addition, the client is able to download the file very quickly because the file is contained in the download plan itself. Different advantages in addition to these, or in place of these, may be present in different embodiments.

The flowchart and block diagrams in the figures illustrate the architecture, functionality, and operation of some possible implementations of systems, methods and computer program products according to various embodiments. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for distributing files, the computer implemented method comprising:
setting a configurable threshold;
responsive to receiving a notification of a file to upload, creating an entry for the file in a database;
determining whether the size of the file is less than the configurable threshold;
responsive to a determination that the size of the file is greater than or equal to the configurable threshold, copying the file to a plurality of servers, and updating the entry in the database by adding the locations of the plurality of servers; and
responsive to a determination that the file is less than the configurable threshold, storing the file in a storage accessible by a central storage manager, and updating the entry in the database with the location of the file.

2. The computer implemented method of claim 1, further comprising:
responsive to receiving a request to download a file from a client, looking up the entry for the file in the database;
determining whether the size of the file is less than the configurable threshold;
responsive to a determination that the size of the file is greater than or equal to the configurable threshold, creating a download plan to use simultaneous downloads of segments of the file from the plurality of servers, wherein the download plan contains the locations of the plurality of servers;
responsive to a determination that the file is less than the configurable threshold, creating a download plan, and copying the file from the storage to the download plan; and
sending the download plan to the client.

3. The computer implemented method of claim 1, wherein the storage is located on at least one of the database, and a second server, wherein the database is located on a first server, and the second server is different than the first server.

4. A computer program product comprising a computer usable medium including computer usable program code for distributing files, the computer program product comprising:
computer usable code for setting a configurable threshold;
responsive to receiving a notification of a file to upload, computer usable code for creating an entry for the file in a database;
computer usable code for determining whether the size of the file is less than a configurable threshold;
responsive to a determination that the size of the file is greater than or equal to the configurable threshold, computer usable code for copying the file to the plurality of servers, and computer usable code for updating the entry in the database by adding the locations of the plurality of servers; and
responsive to a determination that the file is less than the configurable threshold, computer usable code for storing the file in a storage accessible by a central storage manager, and computer usable code for updating the entry in the database with the location of the file.

5. The computer program product of claim 4, further comprising:
responsive to receiving a request to download a file from a client, computer usable code for looking up the entry for the file in the database;
computer usable code for determining whether the size of the file is less than a configurable threshold;
responsive to a determination that the size of the file is greater than or equal to the configurable threshold, computer usable code for creating a download plan to use simultaneous downloads of segments of the file from the plurality of servers, wherein the download plan contains the locations of the plurality of servers;
responsive to a determination that the file is less than the configurable threshold, computer usable code for creating a download plan, and copying the file from the storage to the download plan; and
computer usable code for sending the download plan to the client.

6. The computer program product of claim 4, wherein the storage is located on at least one of the database, and a second server, wherein the database is located on a first server, and the second server is different than the first server.

7. A data processing system for distributing files, the data processing system comprising:
a bus;
a storage device connected to the bus, wherein the storage device contains computer usable code, and wherein the storage device contains a database;
a communications unit connected to the bus; and
a processing unit connected to the bus for executing the computer usable code, wherein the processing unit executes the computer usable code and sets a configurable threshold, responsive to receiving a notification of a file to upload, creates an entry for the file in a database, determines whether the size of the file is less than a configurable threshold, responsive to a determination that the size of the file is greater than or equal to the configurable threshold, copies the file to plurality of servers, and updates the entry in the database by adding the locations of the plurality of servers, and responsive to a determination that the file is less than the configurable threshold, stores the file in a storage accessible by a central storage manager, and updates the entry in the database with the location of the file.

8. The data processing system of claim 7, wherein the processing unit, responsive to receiving a request to download a file from a client, further executes the computer usable code and looks up the entry for the file in the database, determines whether the size of the file is less than a configurable threshold, responsive to a determination that the size of the file is greater than or equal to the configurable threshold, creates a download plan to use simultaneous downloads of segments of the file from the plurality of servers, wherein the download plan contains the locations of the plurality of servers, responsive to a determination that the file is less than the configurable threshold, creates a download plan, and copies the file from the storage to the download plan, and sends the download plan to the client.

9. The data processing system of claim 7, wherein the storage is located on at least one of the database, and a second server, wherein the database is located on a first server, and the second server is different than the first server.

10. The data processing system of claim 7, wherein the processing unit, responsive to receiving a request to download a file from a client, further executes the computer usable code to set the configurable threshold to ten kilobytes.
